(19) United States
(12) Patent Application Publication
(10) Pub. No.: US 2008/0250606 A1
(43) Pub. Date: Oct. 16, 2008

(54) Sliding track assembly, hinge structure and sliding track assembly arrangement

(75) Inventors: Chih-Huang Peng, Sinjhuang City (TW); Wang-Jui Lee, Sinjhuang City (TW)

Correspondence Address: TROXELL LAW OFFICE PLLC, ONE SKYLINE PLACE, 5205 LEESBURG PIKE, SUITE 1404, FALLS CHURCH, VA, 22041, US

(73) Assignee: JARLLYTEC CO., LTD.

(21) Appl. No.: 11/892,254

(22) Filed: Aug. 21, 2007

(30) Foreign Application Priority Data
Apr. 12, 2007 (TW) 096205828

(51) Int. Cl. E05F 1/16

(52) U.S. Cl. 16/353

(57) ABSTRACT

A sliding track assembly is disclosed formed of a sliding member, a track member, a supporting shaft member that is formed of two T-bars arranged together in reversed directions, and pairs of spring members. When moving the sliding member along sliding grooves of the track member, the combined length of the two T-bars is changed, and the spring members release preserved energy to push the sliding member to the extended or received position automatically when the movable fulcrum between the sliding member and the track member passes over the fixed fulcrum. The invention further provides a hinge structure and sliding track assembly arrangement using the said sliding track assembly.

### BACKGROUND OF THE INVENTION

1. Field of the Invention

The present invention relates to a sliding track assembly, which is comprised of a sliding member, a track member, a supporting shaft member, and pairs of spring members. The supporting shaft member is formed of two T-bars coupled to each other through a slip joint and respectively pivoted to the sliding member and the track member. The spring members are coupled between the two T-bars to preserve energy and to release energy during movement of the sliding member relative to the track member. In an alternate form of the present invention, the sliding track assembly is used with two hinges to provide a rotation and angular positioning function.

2. Description of the Related Art

Sliding track assemblies are intensively used in different products around us. For example, a sliding track assembly allows a drawer to be moved in and out of a cabinet. Instead of the use of a hinge in a lifting cover type cell phone, a sliding track assembly may be used in a cell phone for allowing the sliding cover of the cell phone to be moved in and out of the mainframe of the cell phone between the open position and the close position. When the sliding cover is extended out, the operating face panel of the cell phone is exposed to the outside for operation. When the sliding cover is moved to the received (close) position, it keeps the operating face panel of the cell phone from sight. According to conventional designs, the sliding cover must be pushed by hand to the extended or received position. Therefore, the user must employ much effort to move the sliding cover to the extended or received position. It is helpful to provide a sliding track assembly that automatically moves the sliding cover to the extended or received position when the sliding cover passes over a particular position.

Further, a sliding track assembly may be used with hinge means and installed in the cover member and base member of a mobile electronic device, for allowing the user to open/close the cover member and to further lift the cover member after it is opened from the base member.

A sliding track assembly may be used in a cell phone, notebook computer, or flat panel display. During sliding movement, the sliding member of the sliding track assembly must bear the gravity of the supported member, for example, LCD panel. Because of the heavy weight of the supported member, the user needs to employ much effort to move the sliding member and the supported member carried on the sliding member.

Therefore, it is desirable to provide a sliding track assembly that eliminates the aforesaid problem.

### SUMMARY OF THE INVENTION

The present invention has been accomplished under the circumstances in view. It is one object of the present invention to provide a sliding track assembly, which allows adjustment of the spring power subject to the gravity of the object to be carried. It is another object of the present invention to provide a sliding track assembly, which can be used with hinges for allowing change of the angular position between two members of a product as well as sliding adjustment of the two members of the product.

According to one aspect of the present invention, the invention provides a sliding track assembly, which comprises a sliding member, a track member, a supporting shaft member, and at least one pair of spring members. The sliding member has a flat body, two sliding rails arranged in parallel at two opposite lateral sides of the flat body, and a pivot hole disposed adjacent to one sliding rail. The track member has two parallel sliding grooves arranged in parallel at two opposite lateral sides of the flat base thereof for receiving the two sliding rails of the sliding member for allowing movement of the sliding member relative to the track member along the sliding grooves, and a pivot hole disposed adjacent to one sliding groove opposite to the pivot hole of the sliding member. The supporting shaft member is coupled between the sliding member and the track member, comprising a first T-bar and a second T-bar arranged in a stack in reversed directions. The first T-bar and the second T-bar each comprise an elongated head, a shank perpendicularly extending from the elongated head, a pivot hole at one end of the shank remote from the elongated head, a pinhole at an opposite end of the shank adjacent to the elongated head, and a sliding slot extending along the length of the shank and spaced between the pivot hole and the pinhole at the shank. The pivot hole of the first T-bar is pivoted to the pivot hole of the track member. The pivot hole of the second T-bar is pivoted to the pivot hole of the sliding member. The pinhole of the first T-bar is coupled to the sliding slot of the second T-bar with a rivet. The pinhole of the second T-bar is coupled to the sliding slot of the first T-bar with a rivet. The pivot hole of the first T-bar forms with the pivot hole of the sliding member and the associating the rivet a movable fulcrum. The pivot hole of the second T-bar forms with the pivot hole of the track member and the associating the rivet a fixed fulcrum. The spring members are bilaterally coupled between the elongated head of the first T-bar and the elongated head of the second T-bar. When the sliding member is moved along the sliding grooves of the track member, the movable fulcrum is forced over the fixed fulcrum. When the movable fulcrum passes over the fixed fulcrum, the distance between the elongated head of the first T-bar and the elongated head of the second T-bar is changed, and the spring members resume from a stretched status to a retracted status to release preserved energy, moving the sliding member to the extent.

According to another aspect of the present invention, the invention provides a hinge structure and sliding track assembly, which comprises a sliding member, a track member, a supporting shaft member, at least one pair of spring members, and two hinges. The sliding member is affixed to a first external member, for example, the cover member of a mobile electronic device, having a flat body, two sliding rails arranged in parallel at two opposite lateral sides of the flat body, and a pivot hole disposed adjacent to one sliding rail. The track member has two parallel sliding grooves arranged in parallel at two opposite lateral sides of the flat base thereof for receiving the two sliding rails of the sliding member for allowing movement of the sliding member relative to the track member along the sliding grooves, and a pivot hole disposed adjacent to one sliding groove opposite to the pivot hole of the sliding member. The supporting shaft member is coupled between the sliding member and the track member, comprising a first T-bar and a second T-bar arranged in a stack in reversed directions. The first T-bar and the second T-bar each comprise an elongated head, a shank perpendicularly extending from the elongated head, a pivot hole at one end of the shank remote from the elongated head, a pinhole at an opposite end of the shank adjacent to the elongated head, and a sliding slot extending along the length of the shank and spaced between the pivot hole and the pinhole at the shank. The pivot hole of the first T-bar is pivoted to the pivot hole of the track member. The pivot hole of the second T-bar is pivoted to the pivot hole of the sliding member. The pinhole of the first T-bar is coupled to the sliding slot of the second T-bar with a rivet. The pinhole of the second T-bar is coupled to the sliding slot of the first T-bar with a rivet. The pivot hole of the first T-bar forms with the pivot hole of the sliding member and the associating the rivet a movable fulcrum. The pivot hole of the second T-bar forms with the pivot hole of the track member and the associating the rivet a fixed fulcrum. The spring members are bilaterally coupled between the elongated head of the first T-bar and the elongated head of the second T-bar. The two hinges each comprise a fixed hinge member affixed to a second external member, for example, the base member of the aforesaid mobile electronic device, and a movable hinge member respectively affixed to the mounting lugs of the track member. When the sliding member is moved with the cover member of the mobile electronic device along the sliding grooves of the track member, the movable fulcrum is forced over the fixed fulcrum, and when the movable fulcrum passes over the fixed fulcrum, the distance between the elongated head of the first T-bar and the elongated head of the second T-bar is changed, and the spring members resume from a stretched status to a retracted status to release preserved energy, moving the sliding member and the cover member to the extent.

### BRIEF DESCRIPTION OF THE DRAWINGS

FIG. 1 is an exploded view of a sliding track assembly according to the present invention.

FIG. 2 is an elevational assembly view of the sliding track assembly according to the present invention.

FIG. 3 is a schematic drawing of the present invention, showing the sliding member moved along the sliding grooves of the track member to the final point.

FIG. 4 is an exploded view of a hinge structure and sliding track assembly arrangement according to the present invention.

FIG. 5 is an elevational assembly view of the hinge structure and sliding track assembly arrangement according to the present invention

FIG. 6 is a schematic drawing showing the hinge structure and sliding track assembly arrangement of FIG. 5 installed in the cover member and base member of a mobile electronic device and the cover member turned to a vertical position relative to the base member.

FIG. 7 is a schematic drawing corresponding to FIG. 6, showing the cover member lifted with the sliding member relative to the track member and the base member.

### DETAILED DESCRIPTION OF THE PREFERRED EMBODIMENT

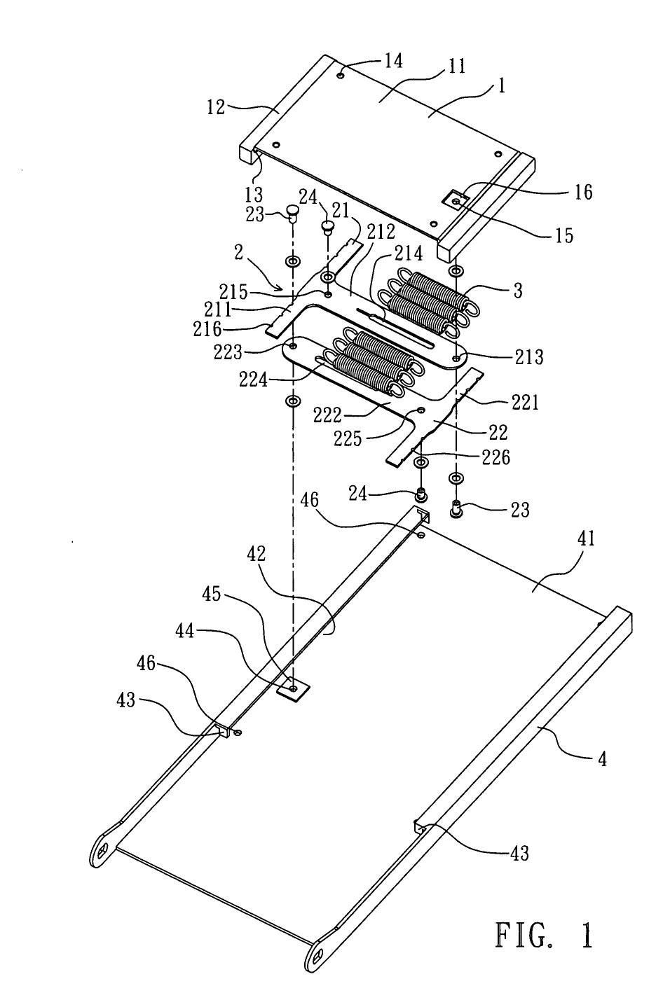

Referring to FIGS. 1˜3, a sliding track assembly in accordance with the present invention is shown comprised of a sliding member 1, a supporting shaft member 2, at least one pair of spring members 3, and a track member 4.

The sliding member 1 comprises a flat body 11 and two parallel sliding rails 12 fastened to two opposite lateral sides of the flat body 11. The sliding rails 12 each have a coupling groove 13 longitudinally disposed at one side. The flat body 11 has its two opposite side edges respectively coupled to the coupling grooves 13 of the sliding rails 12. According to this embodiment, the sliding rails 12 are injection-molded from plastics, such as self-lubrication polymers. According to this embodiment, the sliding rails 12 are injection-molded from polyoxymethylen for the advantages of high toughness and high wearing resistance to achieve high durability. The sliding rails 12 are respectively coupled to two sliding grooves 42 at two sides of the track member 4 so that the sliding member 1 can be moved forth and back along the track member 4.

The flat body 11 has at least one mounting through hole 14 in each of the four corners thereof for the mounting of screws or the like that affix the sliding member 1 to an external object such as the cover member of a mobile electronic device, so that the affixed cover member can be moved with the sliding member 1 relative to the track member 4. The flat body 11 further has a convex portion 16 near one sliding rail 12, and a hole 15 cut through the convex portion 16 for the connection of one end of the supporting shaft member 2.

The supporting shaft member 2 is comprised of a first flat T-bar 21 and a second flat T-bar 22. The first flat T-bar 21 and the second flat T-bar 22 are arranged in a stack in reversed directions. The two flat T-bars 21 and 22 each comprise a shank 212 or 222, and a head 211 or 221 at one end of the shank 212 or 222. The shank 212 or 222 has a pivot hole 213 or 223 at the distal end remote from the head 211 or 221, a pinhole 215 or 225 at the proximal end close to the head 211 or 221, and an elongated sliding slot 214 or 224 spaced between the pivot hole 213 or 223 and the pinhole 215 or 225. Pivot members 23 are respectively inserted through the pivot hole 213 of the first flat T-bar 21 and the pivot hole 223 of the second flat T-bar 22 to pivotally secure the first flat T-bar 21 to the track member 4 and the second flat T-bar 22 to the sliding member 1 respectively. Rivets 24 are respectively fastened to the pinholes 215 and 225 and the elongated sliding slots 224 and 214 to guide relative sliding movement between the first flat T-bar 21 and the second flat T-bar 22. Therefore, the first flat T-bar 21 and the second flat T-bar 22 can be moved relative to each other to adjust the distance between the pivot hole 213 of the first flat T-bar 21 and the pivot hole 223 of the second flat T-bar 22, and the distance between the head 211 of the first flat T-bar 21 and the head 221 of the second flat T-bar 22 is relatively adjusted.

As shown in FIGS. 1˜3, the head 211 of the first flat T-bar 21 and the head 221 of the second flat T-bar 22 each have a plurality of locating notches 216 or 226. The spring members 3 have the respective opposite ends respectively hooked on the locating notches 216 of the head 211 of the first flat T-bar 21 and the locating notches 226 of the head 221 of the second flat T-bar 22.

The track member 4 has a flat base 41, two sliding grooves 42 defined in parallel at two opposite lateral sides of the flat base 41 for receiving the side sliding rails 12 of the sliding member 1 for allowing the sliding member 1 to be moved stably along the track member 4, a stop member 43 at each of the two distal ends of each of the sliding grooves 42 to prevent escaping of the sliding member 1, a convex portion 45 disposed adjacent to one sliding groove 42, a pivot hole 44 cut through the convex portion 45 for the mounting of the pivot member 23 that pivotally secures the second flat T-bar 22 to the track member 4 for allowing the second flat T-bar 22 to make an angular motion on the flat base 41 of the track member 4, and a plurality of mounting through holes 46 in four corners for enabling the track member 4 to be affixed to, for example, the base member of the aforesaid mobile electronic device. The convex portion 45 works as spacer means to prohibit direct contact of the riveted end of the rivet 24 with the flat base 41, preventing friction between the rivet 24 and the track member 4.

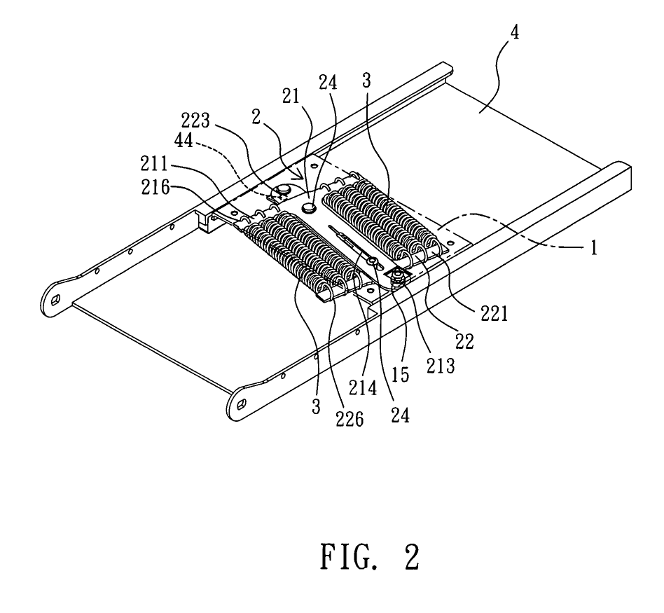

Referring to FIG. 2, when the aforesaid cover member and base member are arranged together, the supporting shaft member 2 does not receive any external pressure. At this time, the distance between the hole 15 of the sliding member 1 and the pivot hole 44 of the track member 4 is at the shortest status; the rivets 24 are respectively stopped at the outer ends of the elongated sliding slots 214 and 224, and the spring members 3 are stretched to preserve energy.

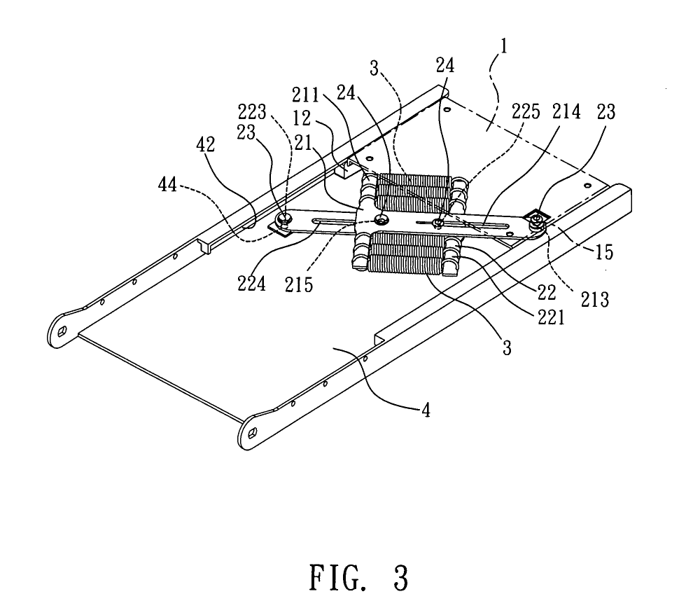

Referring to FIG. 3, when an external push force is applied to the sliding member 1 to move the two sliding rails 12 along the sliding grooves 42 of the track member 4 and when the movable fulcrum formed of the pivot hole 213 of the first T-bar 21 and the hole 15 of the sliding member 1 and the associating the pivot member 23 passes over the fixed fulcrum formed of the pivot hole 223 of the second T-bar 22 and the pivot hole 44 of the track member 4 and the associating the pivot member 23, the distance between the movable fulcrum and the fixed fulcrum is increasing, and therefore the spring members 3 resume to their former retracted status to release preserved energy due to change of the distance between the two T-bars 21 and 22. When the spring members 3 resume to their former retracted status, the rivet 24 at the pinhole 215 of the first T-bar 21 moves along the elongated sliding slot 224 of the second T-bar 22, and the elongated sliding slot 214 of the first T-bar 21 is moved relative to the rivet 24 at the pinhole 225 of the second T-bar 22, shortening the distance between the two rivets 24, i.e., shortening the distance between the head 211 of the first T-bar 21 and the head 221 of the second T-bar 22, and therefore the sliding member 1 is extended out of the track member 4, i.e., the cover member is extended out of the base member. When closing the cover member, reverse the aforesaid procedure.

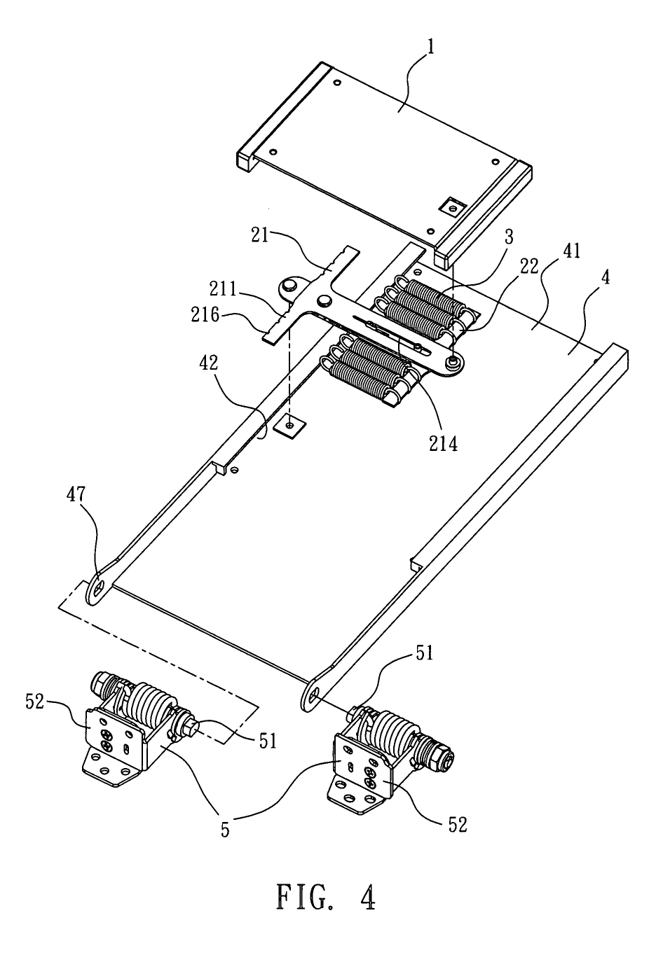

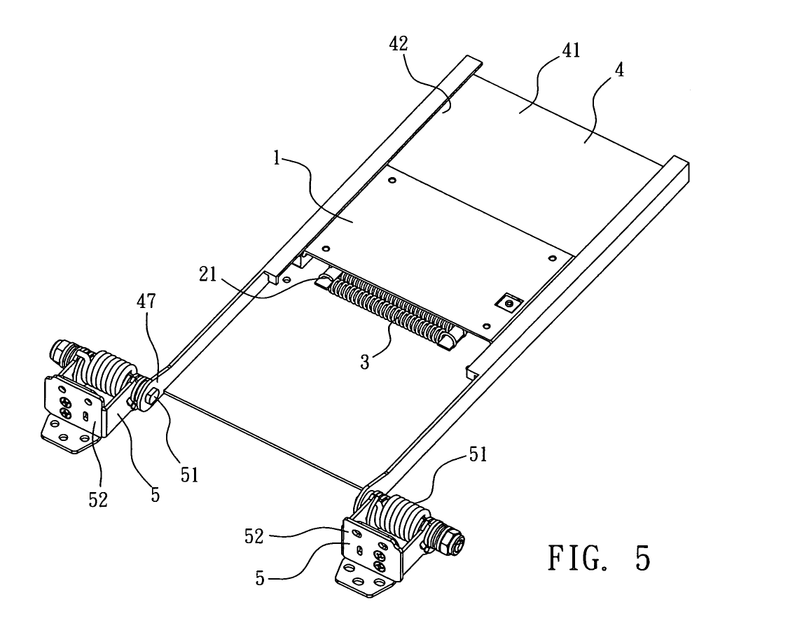

FIGS. 4 and 5 show a hinge structure and sliding track assembly arrangement according to the present invention. In addition to the sliding function of the aforesaid sliding track assembly, this embodiment provides an additional rotation and angular positioning function. According to this embodiment, the flat base 41 of the track member 4 has two lugs 47 respectively extending from the sliding grooves 42 and respectively coupled to a respective hinge 5.

The hinge 5 comprises a fixed hinge member 52 and a movable hinge member 51 pivoted to the fixed hinge member 52, allowing the movable hinge member 51 to be turned relative to the fixed hinge member 52 within a predetermined angle and then positioned in the desired angular position. The movable hinge member 51 and the fixed hinge member 52 can be pivoted together by means of an axial (series connection type) pivot means or radial (sleeved joint type) pivot means. Because the hinge 5 can be obtained from conventional techniques, no further detailed description in this regard is necessary.

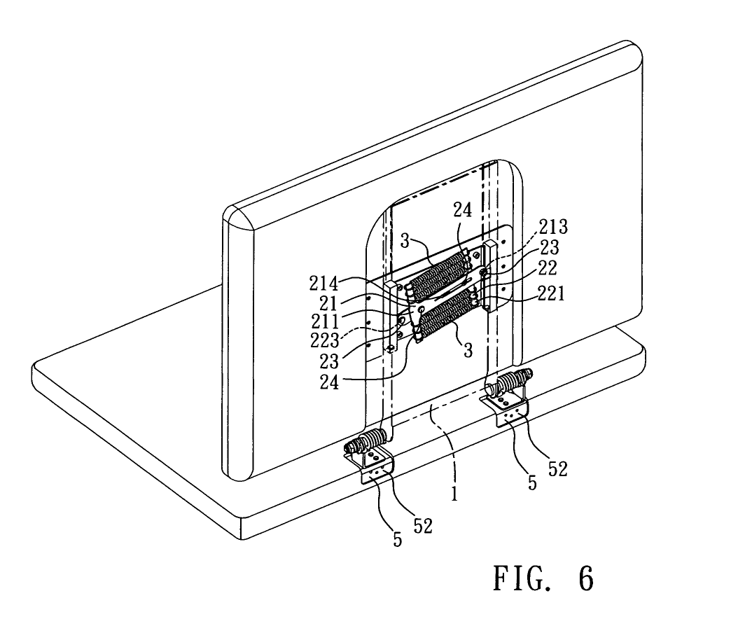

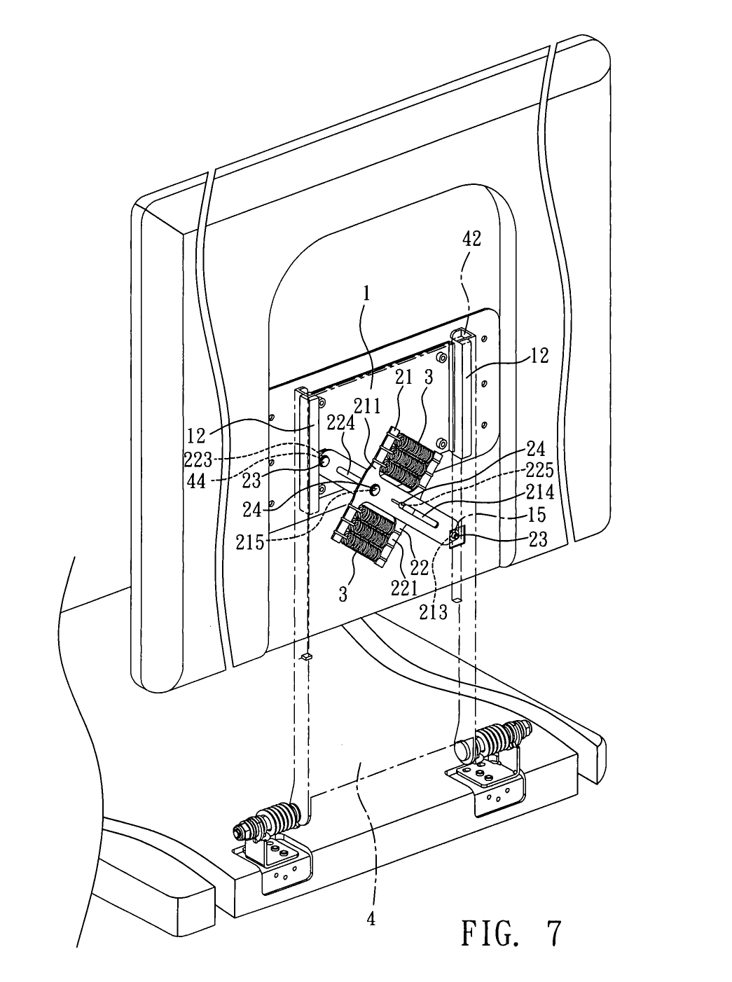

FIGS. 6 and 7 show the hinge structure and sliding track assembly arrangement of the present invention used in the cover member and base member of a mobile electronic device. As illustrated, the fixed hinge members 52 of the hinges 5 are affixed to the base member of the mobile electronic device to have the track member 4 be inserted into the inside of the cover member of the mobile electronic device, and the sliding member 1 is affixed to the cover member of the mobile electronic device. Thus, the cover member of the mobile electronic device can be moved with the sliding member 1 relative to the track member 4 and the base member of the mobile electronic device, and turned with the sliding member 1 through an angle relative to the track member 4 and the base member of the mobile electronic device. As shown in FIG. 6, the cover member is turned through 90-degrees and positioned in vertical relative to the horizontally extending base member. At this time, the sliding track assembly does no work, i.e., the distance between the hole 15 of the sliding member 1 and the pivot hole 44 of the track member 4 is at the shortest status, the rivets 24 are respectively stopped at the outer ends of the elongated sliding slots 214 and 224, and the spring members 3 are stretched to preserve energy.

Referring to FIG. 7, when wishing to lift the cover member of the mobile electronic device, pull the cover member upwards directly. At this time, the sliding rails 12 of the sliding member 1 are moved with the cover member of the mobile electronic device along the sliding grooves 42 of the track member 4. When the movable fulcrum formed of the pivot hole 213 of the first T-bar 21 and the hole 15 of the sliding member 1 and the associating the pivot member 23 passes over the fixed fulcrum formed of the pivot hole 223 of the second T-bar 22 and the pivot hole 44 of the track member 4 and the associating the pivot member 23, the distance between the movable fulcrum and the fixed fulcrum is increasing, and therefore the spring members 3 resume to their former retracted status to release preserved energy due to change of the distance between the two T-bars 21 and 22. According to this embodiment, three pairs of spring members 3 are used and bilaterally coupled between the head 211 of the first T-bar 21 and the head 221 of the second T-bar 22 to support the gravity of the cover member. When the preserved energy of the spring members 3 is released, the cover member and the sliding member 1 are automatically lifted from the track member 4. When returning the cover member, move the cover member and the sliding member 1 in the reverse direction.

As indicated above, the energy preserving and releasing function of the spring members between the first T-bar and the second T-bar facilitates the operation of the sliding track assembly, i.e., the user needs not to move the sliding member through the entire stroke. When the movable fulcrum passes over the fixed fulcrum, the sliding member is automatically moved to the extended or received position. Further, the sliding member has two lugs for connection to a respective hinge, forming a hinge structure and sliding track assembly arrangement. When the hinge structure and sliding track assembly arrangement is used in a mobile electronic device, the sliding member is affixed to the cover member of the mobile electronic device, and the hinges are affixed to the base member of the mobile electronic device. After installation, the cover member of the mobile electronic device can be turned with the sliding track assembly and the movable hinge members of the hinges to the desired angle relative to the base member of the movable electronic device and the fixed hinge members of the hinges. Further, the number of the spring members may be changed subject to the gravity of the cover member of the mobile electronic device.

Although the present invention has been explained in relation to its preferred embodiments, it is to be understood that many other possible modifications and variations can be made without departing from the spirit and scope of the invention as hereinafter claimed.

What is claimed is:

1. A sliding track assembly comprising:
a sliding member, said sliding member having a flat body, two sliding rails arranged in parallel at two opposite lateral sides of said flat body, and a pivot hole disposed adjacent to one of said sliding rails;
a track member, said track member having two parallel sliding grooves arranged in parallel at two opposite lateral sides of a flat base thereof for receiving the two sliding rails of said sliding member for allowing movement of said sliding member relative to said track member along said sliding grooves, and a pivot hole disposed adjacent to one of said sliding grooves opposite to the pivot hole of said sliding member;
a supporting shaft member coupled between said sliding member and said track member, said supporting shaft member comprising a first T-bar and a second T-bar arranged in a stack in reversed directions, said first T-bar and said second T-bar each comprising an elongated head, a shank perpendicularly extending from said elongated head, a pivot hole at one end of said shank remote from said elongated head, a pinhole at an opposite end of said shank adjacent to said elongated head, and a sliding slot extending along the length of said shank and spaced between the pivot hole and the pinhole at said shank, the pivot hole of said first T-bar being pivoted to the pivot hole of said track member, the pivot hole of said second T-bar being pivoted to the pivot hole of said sliding member, the pinhole of said first T-bar being coupled to the sliding slot of said second T-bar with a rivet and the pinhole of said second T-bar being coupled to the sliding slot of said first T-bar with a rivet, the pivot hole of said first T-bar and the pivot hole of said sliding member and the associating the rivet forming a movable fulcrum, the pivot hole of said second T-bar and the pivot hole of said track member and the associating the rivet forming a fixed fulcrum; and
at least one pair of spring members bilaterally coupled between the elongated head of said first T-bar and the elongated head of said second T-bar;
wherein when said sliding member is moved along the sliding grooves of said track member, said movable fulcrum is forced over said fixed fulcrum, and when said movable fulcrum passes over said fixed fulcrum, the distance between the elongated head of said first T-bar and the elongated head of said second T-bar is changed and said spring members resume from a stretched status to a retracted status to release preserved energy, moving said sliding member to the extent.

2. The sliding track assembly as claimed in claim 1, wherein said sliding rails each having a coupling groove at an inner side thereof; said flat body of sliding member has the two opposite lateral sides thereof respectively coupled to the coupling grooves of said sliding rails.

3. The sliding track assembly as claimed in claim 1, wherein said sliding rails are injection-molded from a polymeric plastic material.

4. The sliding track assembly as claimed in claim 3, wherein said polymeric plastic material is a self-lubrication plastic material.

5. The sliding track assembly as claimed in claim 1, wherein said flat base of said track member has a plurality of mounting through holes affixed to a first external member; said flat body of said sliding member has a plurality of mounting through holes affixed to a second external member.

6. The sliding track assembly as claimed in claim 1, wherein said track member has a stop device respectively disposed at each of two distal ends of each of said sliding grooves.

7. The sliding track assembly as claimed in claim 1, the elongated heads of said first T-bar and said second T-bar each have a plurality of notches; said spring members each have two distal ends respectively hooked on the notches of the elongated heads of said first T-bar and said second T-bar.

8. A hinge structure and sliding track assembly arrangement comprising:
a sliding member affixed to a first external member, said sliding member having a flat body, two sliding rails arranged in parallel at two opposite lateral sides of said flat body, and a pivot hole disposed adjacent to one of said sliding rails;
a track member, said track member having two parallel sliding grooves arranged in parallel at two opposite lateral sides of a flat base thereof for receiving the two sliding rails of said sliding member for allowing movement of said sliding member relative to said track member along said sliding grooves, two mounting lugs respectively axially extending from one end of each of said sliding grooves, and a pivot hole disposed adjacent to one of said sliding grooves opposite to the pivot hole of said sliding member;
a supporting shaft member coupled between said sliding member and said track member, said supporting shaft member comprising a first T-bar and a second T-bar arranged in a stack in reversed directions, said first T-bar and said second T-bar each comprising an elongated head, a shank perpendicularly extending from said elongated head, a pivot hole at one end of said shank remote from said elongated head, a pinhole at an opposite end of said shank adjacent to said elongated head, and a sliding slot extending along the length of said shank and spaced between the pivot hole and the pinhole at said shank, the pivot hole of said first T-bar being pivoted to the pivot hole of said track member, the pivot hole of said second T-bar being pivoted to the pivot hole of said sliding member, the pinhole of said first T-bar being coupled to the sliding slot of said second T-bar with a rivet and the pinhole of said second T-bar being coupled to the sliding slot of said first T-bar with a rivet, the pivot hole of said first T-bar and the pivot hole of said sliding member and the associating the rivet forming a movable fulcrum, the pivot hole of said second T-bar and the pivot hole of said track member and the associating the rivet forming a fixed fulcrum;
at least one pair of spring members bilaterally coupled between the elongated head of said first T-bar and the elongated head of said second T-bar; and
two hinges, said hinges each comprising a fixed hinge member affixed to a second external member, and a movable hinge member respectively affixed to said mounting lugs of said track member;
wherein when said sliding member is moved with said first external member along the sliding grooves of said track member, said movable fulcrum is forced over said fixed fulcrum, and when said movable fulcrum passes over said fixed fulcrum, the distance between the elongated head of said first T-bar and the elongated head of said second T-bar is changed and said spring members resume from a stretched status to a retracted status to release preserved energy, moving said sliding member to the extent.

9. The sliding track assembly as claimed in claim 8, wherein said sliding rails each having a coupling groove at an inner side thereof; said flat body of sliding member has the two opposite lateral sides thereof respectively coupled to the coupling grooves of said sliding rails.

10. The sliding track assembly as claimed in claim 8, wherein said sliding rails are injection-molded from a polymeric plastic material.

11. The sliding track assembly as claimed in claim 10, wherein said polymeric plastic material is a self-lubrication plastic material.

12. The sliding track assembly as claimed in claim 8, wherein said track member has a stop device respectively disposed at each of two distal ends of each of said sliding grooves.

13. The sliding track assembly as claimed in claim 8, the elongated heads of said first T-bar and said second T-bar each have a plurality of notches; said spring members each have two distal ends respectively hooked on the notches of the elongated heads of said first T-bar and said second T-bar.
